(19) United States
(12) Patent Application Publication
(10) Pub. No.: US 2021/0128279 A1
(43) Pub. Date: May 6, 2021

(54) DRILL-LESS DENTAL IMPLANT AND USES THEREOF

(71) Applicant: CORTEX DENTAL IMPLANTS INDUSTRIES LTD., Shlomi (IL)

(72) Inventors: MEIR MAMRAEV, RISHON LEZION (IL); ZVI LASTER, PORIYA ELITE (IL)

(21) Appl. No.: 17/148,195

(22) Filed: Jan. 13, 2021

Related U.S. Application Data
(63) Continuation-in-part of application No. 16/069,084, filed on Jul. 10, 2018.

(30) Foreign Application Priority Data
Jan. 10, 2016 (IL) 243523

(51) Int. Cl. A61C 8/00

(52) U.S. Cl. CPC A61C 8/0022; A61C 8/0037

(57) ABSTRACT

A drill-less dental implant to be implanted in a jaw bone comprises a screw thread comprising a core having a surface and a sharp tip and a spiral protrusion extending from the surface, wherein when the screw thread is rotationally screwed into the jaw bone, the sharp tip linearly penetrates the jaw bone, and a prosthesis support is attached to an upper edge of the screw thread and configured to support a dental prosthesis. A method of implanting the drill-less dental implant without drilling prior to the implantation is also provided.

### CROSS-REFERENCE TO RELATED APPLICATIONS

This application is a continuation-in-part of U.S. patent application Ser. No. 16/069,084, filed Jul. 10, 2018, which claims priority to International Patent Application No. PCT/IL2016/051369, filed Dec. 22, 2016, which claims priority to Israeli Patent Application No. 243523, filed Jan. 10, 2016, which are incorporated herein by reference in their entirety.

### FIELD OF THE INVENTION

The present subject matter relates to dental implants. More particularly, the present subject matter relates to drill-less dental implants.

### BACKGROUND OF THE INVENTION

A dental implant is a surgical component that interfaces with a jaw bone to support dental prosthesis such as a crown, bridge, denture, and facial prosthesis. Some types of dental implants rely on the process of osseointegration, where the dental implant forms an intimate bond with the jaw bone tissue. Osseointegration is facilitated for example by using titanium as a material for the preparation of a dental implant, and inclusion of pores in the dental implant to allow the growth of bone tissue extensions into the pores. Currently, prior to implanting a dental implant the jaw bone is drilled in order to facilitate insertion of the dental implant into the jaw bone. Following insertion of the dental implant into the jaw bone, a healing time is required for osseointegration to occur in order to increase the fixation of the dental implant in the jaw bone before loading the dental implant with either a dental prosthetic or an abutment to which a dental prosthetic is attached.

Prior to the implantation of a dental implant, a drilling process is conducted, involving a series of drills, each with an increasing diameter, in order to prepare a hole into which the dental implant is to be implanted. The drilling process has several disadvantages, for example, inability to control the direction of drilling and loss of jaw bone tissue during drilling, which results in a low amount of jaw bone tissue that is left to hold the dental implant, especially when there is a need to implant the dental implant in a narrow jaw bone tissue, like in the front side of the lower jaw.

### SUMMARY OF THE INVENTION

Unless otherwise defined, all technical and scientific terms used herein have the same meaning as commonly understood by one of ordinary skill in the art to which this subject matter belongs. Although methods and materials similar or equivalent to those described herein can be used in the practice or testing of the present subject matter, suitable methods and materials are described below. In case of conflict, the patent specification, including definitions, will control. In addition, the materials, methods, and examples are illustrative only and not intended to be limiting.

According to one aspect of the present subject matter, there is provided a drill-less dental implant to be implanted in a jaw bone, comprising:
a screw thread comprising a core having a surface and a sharp tip and a spiral protrusion extending from the surface, wherein when the screw thread is rotationally screwed into the jaw bone, the sharp tip linearly penetrates the jaw bone; and
a prosthesis support attached to an upper edge of the screw thread and configured to support a dental prosthesis.

According to one embodiment, the spiral protrusion extends from an entire surface of the core, from the sharp tip up to the prosthesis support.

According to another embodiment, the core is substantially conical.

According to yet another embodiment, an upper part of the core is cylindrical, and a rest of the core down toward the sharp tip is conical.

According to a further embodiment, a minimal diameter of the screw thread just above the sharp tip is in a range of substantially 0.55 to 0.57 mm.

According to yet a further embodiment, a minimal diameter of the screw thread just above the sharp tip is substantially 0.56 mm.

According to yet a further embodiment, the sharp tip has a length that is less than 0.45 mm.

According to another aspect of the present subject matter, there is provided a method for implanting a drill-less dental implant in a jaw bone, comprising positioning the aforementioned drill-less dental implant on top of a desired implantation site in the jaw bone and rotationally screwing while linearly inserting, the drill-less dental implant into the jaw bone until the drill-less dental implant is inserted into the jaw bone in a desired depth.

According to one embodiment, the method for implanting a drill-less dental implant in a jaw bone further comprises puncturing a starter hole in a jaw bone before the rotationally screwing and thereby linearly inserting the drill-less dental implant into the jaw bone.

According to another embodiment, the puncturing of the starter hole in the jaw bone is with the sharp tip of the drill-less dental implant.

According to yet another embodiment, the method for implanting a drill-less dental implant in a jaw bone further comprises during the rotationally screwing and thereby linearly inserting the drill-less dental implant into the jaw bone, adjusting a direction of insertion of the drill-less dental implant into the jaw bone.

According to still another embodiment, the adjusting the direction of insertion of the drill-less dental implant into the jaw bone comprises tilting the drill-less dental implant to a desired direction.

### BRIEF DESCRIPTION OF THE DRAWINGS

Embodiments are herein described, by way of example only, with reference to the accompanying drawings. With specific reference now to the drawings in detail, it is stressed that the particulars shown are by way of example and for purposes of illustrative discussion of the preferred embodiments, and are presented in the cause of providing what is believed to be the most useful and readily understood description of the principles and conceptual aspects of the embodiments. In this regard, no attempt is made to show structural details in more detail than is necessary for a fundamental understanding, the description taken with the drawings making apparent to those skilled in the art how several forms may be embodied in practice.

In the drawings:

FIG. 1 schematically illustrates, according to an exemplary embodiment, a perspective view of a prior art dental implant requiring a drilling process of a jaw bone before implantation.

FIGS. 2A-C schematically illustrate, according to some exemplary embodiments, a cross-section view, a front view, and a perspective view, respectively, of a drill-less dental implant.

FIG. 3 schematically illustrating, according to an exemplary embodiment, a cross-section view of a jaw bone.

FIGS. 4A-D schematically illustrate, according to some exemplary embodiments, steps of a method for implanting a drill-less dental implant in a jaw bone, showing a cross-section view of a jaw bone and a cross-section view of a drill-less dental implant during operation of the method.

FIG. 5 schematically illustrates, according to an exemplary embodiment, a starter hole punctured in a jaw bone.

### DESCRIPTION OF THE PREFERRED EMBODIMENTS

Before explaining at least one embodiment in detail, it is to be understood that the subject matter is not limited in its application to the details of construction and the arrangement of the components set forth in the following description or illustrated in the drawings. The subject matter is capable of other embodiments or of being practiced or carried out in various ways. Also, it is to be understood that the phraseology and terminology employed herein is for the purpose of description and should not be regarded as limiting. In discussion of the various figures described herein below, like numbers refer to like parts. The drawings are generally not to scale.

For clarity, non-essential elements were omitted from some of the drawings.

One object of the present subject matter is to provide a dental implant that does not require a drilling process in a jaw bone prior to the implantation of a drill-less dental implant.

Another object of the present subject matter is to provide a drill-less dental implant that enables compression of a jaw bone tissue during the implantation of the dental implant.

Yet another object of the present subject matter is to provide a drill-less dental implant that enables adjustment of the direction of insertion of the drill-less dental implant into a jaw bone during the implantation of the drill-less dental implant.

A further object of the present subject matter is to provide a method for implanting a drill-less dental implant without a need for drilling a jaw bone prior the implantation.

Yet a further object of the present subject matter is to provide a method for implanting a drill-less dental implant that enables compression of a jaw bone tissue during the implantation of the drill-less dental implant.

Still a further object of the present subject matter is to provide a method for implanting a drill-less dental implant that enables adjustment of the direction of insertion of the drill-less dental implant into a jaw bone during the implantation of the drill-less dental implant.

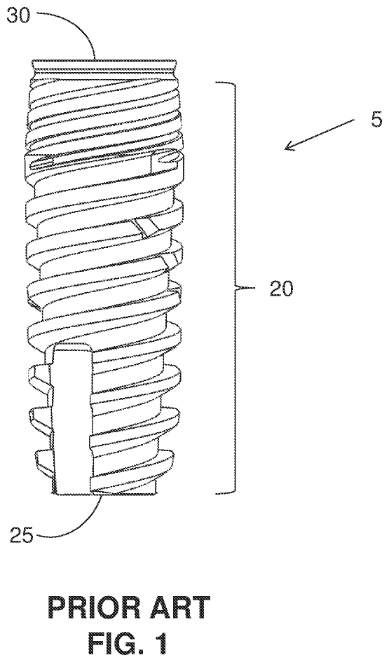

Referring now to FIG. 1 schematically illustrating, according to an exemplary embodiment, a perspective view of a prior art dental implant requiring a drilling process of a jaw bone before implantation. The prior art dental implant 5 comprises a screw thread 20 configured to be rotationally screwed into a drilled hole in a jaw bone, and a prosthesis support 30 configured to support a dental prosthesis, for example a crown, a bridge, a denture, a combination therewith and the like. The prosthesis support 30 is positioned at an upper edge of the prior art dental implant 5. In addition, a lower edge 25 of the prior art dental implant 5 is typically blunt as illustrated in FIG. 1. Furthermore, a core of the prior art dental implant 5 is substantially cylindrical, in other words, a diameter of the lower edge 25 of the prior art dental implant 5 is substantially similar to the diameter of an upper edge of the prior art dental implant 5, where the prosthesis support 30 is positioned.

According an aspect of the present subject matter, a drill-less dental implant to be implanted in a jaw bone is provided that comprises:
a screw thread comprising a core having a surface and a sharp tip and a spiral protrusion extending from the surface, wherein when the screw thread is rotationally screwed into the jaw bone, the sharp tip linearly penetrates the jaw bone; and
a prosthesis support attached to an upper edge of the screw thread and configured to support a dental prosthesis.

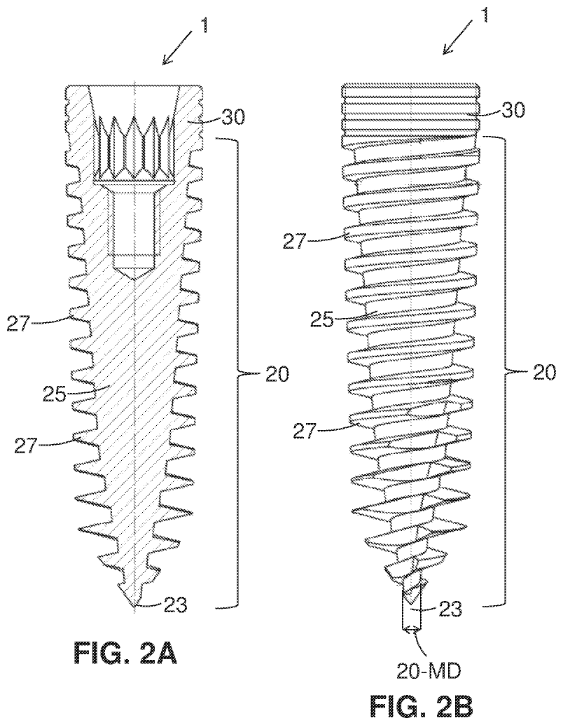

Referring now to FIGS. 2A-C schematically illustrating, according to some exemplary embodiments, a cross-section view, a front view, and a perspective view, respectively, of a drill-less dental implant. FIGS. 2A-C illustrate a drill-less dental implant 1 comprising a screw thread 20 configured to be rotationally screwed into a jaw bone and a prosthesis support 30 attached to an upper edge of the screw thread 20 and configured to support a dental prosthesis. The screw thread 20 has a sharp tip 23 acts as a spearhead and configured to linearly penetrate into a jaw bone when the screw thread 20 is rotationally screwed into the jaw bone.

According to one embodiment, the screw thread 20 comprises a core 25 and a spiral protrusion 27 extending from a surface of the core 25. According to this embodiment, the sharp tip 23 is of the core 25. According to another embodiment, the spiral protrusion 27 is extended from the entire surface of the core 25, namely, from the sharp tip 23 up to the prosthesis support 30. According to yet another embodiment, the shape of the entire core 25 is substantially conical, when the diameter of the core 25 near the prosthesis support 30 is of the highest value, and the diameter of the body 25 gradually decreases towards the sharp tip 23, when the diameter of the body 25 at the sharp tip 23 is the shortest. According to still another embodiment, an upper part of the core 25, adjacent to the prosthesis support 30, is cylindrical, and the rest of the core 25 down towards the sharp tip 23 is conical.

According to one embodiment, shown in FIG. 2B, a minimal diameter 20-MD of the core 25 just above the sharp tip 23 is in the range of substantially 0.55 to 0.57 mm According to another embodiment, the minimal diameter 20-MD of the core 25 just above the sharp tip 23 is substantially 0.56 mm Beneath the prosthesis support 30, the diameter of the core is substantially 3.2 to 3.5 mm. The length of the sharp tip 23 before the spiral protrusion 27 starts is less than 0.45 mm the overall length of the implant is 16 mm.

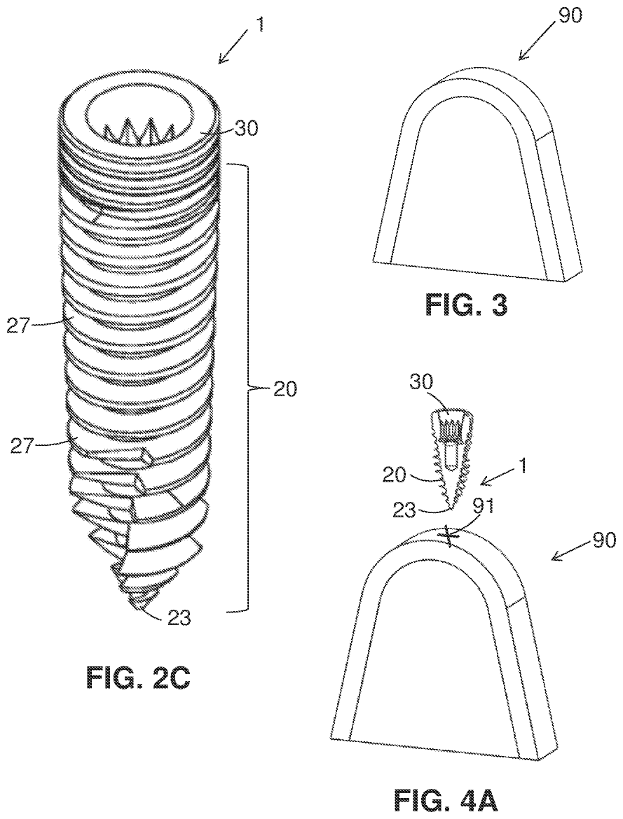

Referring now to FIG. 3 schematically illustrating, according to an exemplary embodiment, a cross-section view of a jaw bone 90. FIG. 3 illustrates a representative jaw bone in which the drill-less dental implant is to be implanted without drilling a hole in the jaw bone 90 for accommodating the drill-less dental implant.

According to another aspect of the present subject matter, a method for implanting a drill-less dental implant in a jaw bone is provided that comprises:
positioning the drill-less dental implant of claim 1 on top of a desired implantation site in the jaw bone; and
rotationally screwing while linearly inserting, the drill-less dental implant into the jaw bone until the drill-less dental implant is inserted into the jaw bone in a desired depth.

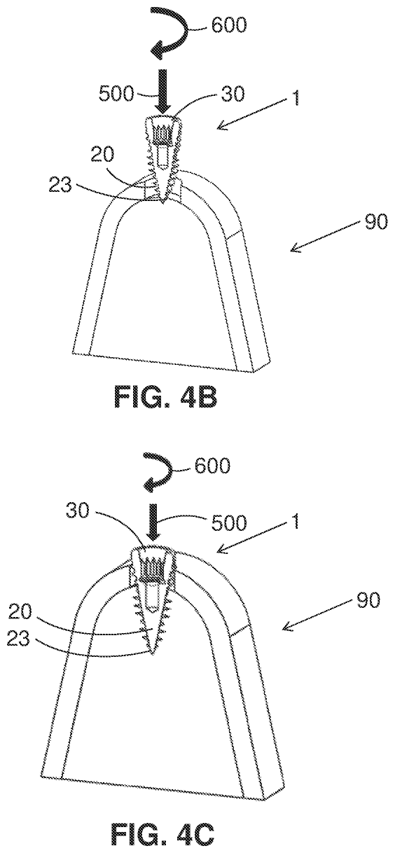

Referring now to FIGS. 4A-D schematically illustrating, according to some exemplary embodiments, steps of a method for implanting a drill-less dental implant in a jaw bone, showing a cross-section view of a jaw bone 90 and a cross-section view of a drill-less dental implant 1 during operation of the method. The method for implanting a drill-less dental implant 1 in a jaw bone 90 comprises:
positioning a drill-less dental implant 1 on top of a desired implantation site 91 in the jaw bone 90, as shown in FIG. 4A. The sharp tip is positioned adjacent to the desired implantation site 91.
rotationally screwing, as indicated with arrow 600, and thereby linearly inserting, as indicated with arrow 500, the drill-less dental implant 1 into the jaw bone 90, as shown sequentially in FIGS. 4B-C, until the drill-less dental implant 1 is inserted into the jaw bone 90 to a desired depth, as illustrated in FIG. 4D.

It should be noted that due to the fact that the sharp tip is very short and the thread screw begins in such a low level of the length of the drill-less dental implant, it is possible to start rotating and screwing the implant without pushing it into the bone prior to rotating it.

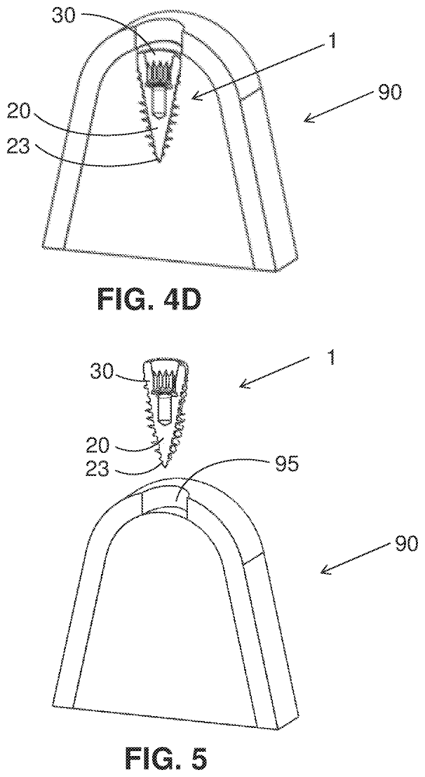

Referring now to FIG. 5 schematically illustrating, according to an exemplary embodiment, a starter hole 95 punctured in a jaw bone 90. FIG. 5 illustrates an additional optional embodiment of the method for implanting a drill-less dental implant 1 in a jaw bone 90. According to this embodiment, before rotationally screwing and thereby linearly inserting the drill-less dental implant 1 into the jaw bone 90, there is an optional step of puncturing a starter hole 95 in the jaw bone 90, for example in order to facilitate proper positioning of the sharp tip 23 of the drill-less dental implant right in the desired implantation site 91.

According to one embodiment, puncturing the starter hole 95 in a jaw bone 90 is with the sharp tip 23 of the drill-less dental implant 1. According to another embodiment, puncturing the starter hole 95 in a jaw bone 90 is with any tool that is configured to puncture a hole in the jaw bone 90, for example a low diameter drill, a nail, a combination thereof, and the like.

According to an additional embodiment, in case there is a need to adjust the direction of insertion of the drill-less dental implant 1 into the jaw bone 90, the method for implanting a drill-less dental implant 1 in a jaw bone 90 further comprises rotationally screwing and thereby linearly inserting the drill-less dental implant 1 into the jaw bone 90—adjusting a direction of insertion of the drill-less dental implant 1 into the jaw bone 90. This can be accomplished, for example, by tilting the drill-less dental implant 1 to a desired direction during the rotational screwing and thereby linear insertion of the drill-less dental implant 1 into the jaw bone 90.

One advantage of the method for implanting a drill-less dental implant 1 of the present subject matter over the currently widely used prior art method for implanting a dental implant involving a drilling process of a hole in a jaw bone for accommodating the dental implant, is that the method of the present subject matter allows adjustment of the direction of penetration of the drill-less dental implant 1 into the jaw bone 90 during the rotational screwing and thereby linear insertion of the drill-less dental implant 1 into the jaw bone 90, without causing damage to the jaw bone 90 tissue, in comparison to the prior art method involving drilling in the jaw bone tissue where any mistake in the drilling may complicate the implantation procedure and require a long and unpleasant process of bone building to fill-in the undesired loss of jaw bone tissue due to the incorrect drilling. The drill-less dental implant 1 and the method for implantation of the present invention negates this kind of complication, as no drilling of the jaw bone 90 is needed. Nevertheless, in some embodiments, a starter hole 95 can only be needed in order to facilitate the insertion of the drill-less dental implant 1 into the jaw bone 90.

Another advantage of the method for implanting a drill-less dental implant 1 of the present subject matter is its suitability to narrow jaw bones, like a frontal side of a lower jaw. Drilling a hole in such narrow jaw bone tissues removes a great amount to tissue from the jaw bone while the mass and strength of the remaining tissue cannot be enough for stably accommodate a dental implant. On the other hand, implanting a drill-less dental implant 1 according to the present subject matter does not require removal of jaw bone 90 tissue, thus leaving enough tissue to stably accommodate the drill-less dental implant 1.

Yet another advantage of the method for implanting a drill-less dental implant 1 of the present subject matter is compression of a jaw bone tissue that is achieved by implanting the drill-less dental implant 1 without pre-drilling of the jaw bone 90. Drilling a hole in the jaw bone removes jaw bone tissue, while the compression state of the remaining jaw bone tissue is not changed. On the other hand, implanting the drill-less dental implant 1 of the present subject matter directly in a jaw bone 90 compresses the jaw bone 90 tissue that surrounds the site of implantation of the drill-less dental implant 1, and thus increases the forces that are exerted by the compressed jaw bone 90 tissue toward the drill-less dental implant 1. As a result, the stability of the drill-less dental implant 1 in the jaw bone 90 is increased.

It is appreciated that certain features of the subject matter, which are, for clarity, described in the context of separate embodiments, may also be provided in combination in a single embodiment. Conversely, various features of the subject matter, which are, for brevity, described in the context of a single embodiment, may also be provided separately or in any suitable sub combination.

Although the subject matter has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A drill-less dental implant to be implanted in a jaw bone, comprises:
a screw thread comprising a core having a surface and a sharp tip and a spiral protrusion extending from the surface, wherein when the screw thread is rotationally screwed into the jaw bone, the sharp tip linearly penetrates the jaw bone; and
a prosthesis support attached to an upper edge of the screw thread and configured to support a dental prosthesis.

2. The drill-less implant of claim 1, wherein the spiral protrusion extends from an entire surface of the core, from the sharp tip up to the prosthesis support.

3. The drill-less dental implant of claim 1, wherein the core is substantially conical.

4. The drill-less dental implant of claim 1, wherein an upper part of the core is cylindrical, and a rest of the core down towards the sharp tip is conical.

5. The drill-less dental implant of claim 1, wherein a minimal diameter of the core above the sharp tip is in a range of substantially 0.55 to 0.57 mm.

6. The drill-less dental implant of claim 1, wherein a minimal diameter of the core above the sharp tip is substantially 0.56 mm.

7. The drill-less dental implant of claim 1, wherein the sharp tip has a length that is less than 0.45 mm.

8. A method for implanting a drill-less dental implant in a jaw bone, comprising:
positioning the drill-less dental implant of claim 1 on top of a desired implantation site in the jaw bone; and
rotationally screwing while linearly inserting, the drill-less dental implant into the jaw bone until the drill-less dental implant is inserted into the jaw bone in a desired depth.

9. The method for implanting a drill-less dental implant in a jaw bone of claim 8, further comprising puncturing a starter hole in a jaw bone before the rotationally screwing while linearly inserting the drill-less dental implant into the jaw bone.

10. The method for implanting a drill-less dental implant in a jaw bone of claim 9, wherein the puncturing of the starter hole in the jaw bone is performed with the sharp tip of the drill-less dental implant.

11. The method for implanting a drill-less dental implant in a jaw bone of claim 8, further comprising during the rotationally screwing while linearly inserting the drill-less dental implant into the jaw bone, adjusting a direction of insertion of the drill-less dental implant into the jaw bone.

12. The method for implanting a drill-less dental implant in a jaw bone of claim 11, wherein the adjusting the direction of insertion of the drill-less dental implant into the jaw bone comprises tilting the drill-less dental implant to a desired direction.
